(19) United States
(12) Patent Application Publication
(10) Pub. No.: US 2021/0231260 A1
(43) Pub. Date: Jul. 29, 2021

(54) GIMBAL

(71) Applicant: SZ DJI TECHNOLOGY CO., LTD., Shenzhen (CN)

(72) Inventors: Minzhao XIE, Shenzhen (CN); Tianfei ZHAO, Shenzhen (CN)

(73) Assignee: SZ DJI TECHNOLOGY CO., LTD., Shenzhen (CN)

(21) Appl. No.: 17/143,041

(22) Filed: Jan. 6, 2021

Related U.S. Application Data
(63) Continuation of application No. PCT/CN2019/093238, filed on Jun. 27, 2019.

(51) Int. Cl. F16M 13/04; F16M 11/20; F16M 11/10; F16M 11/18; H02G 3/38; H01B 7/00; G03B 17/56

(52) U.S. Cl. CPC F16M 13/04; F16M 11/2064; F16M 11/105; G03B 17/561; H02G 3/38; H01B 7/0045; F16M 11/18

(57) ABSTRACT

A gimbal of the present disclosure includes a first shaft assembly, a second shaft assembly, and a wire harness. The first shaft assembly includes a first shaft arm and a first motor having a motor shaft with a hollow structure. A first wiring space is formed in the first shaft arm. The second shaft assembly includes a second shaft arm and a second motor rotatably connected to the first shaft arm. A second wiring space is formed in the second shaft arm. The wire harness passes through the motor shaft, the first wiring space, and the second wiring space in sequence. The first wiring space is configured so that when the gimbal switches between a folded state and a deployed state, a bending radius of a bending part of the wire harness accommodated in the first wiring space is no less than a minimum bending radius of the wire harness.

### RELATED APPLICATIONS

The present patent document is a continuation application of PCT Application Serial No. PCT/CN2019/093238, filed on Jun. 27, 2019, designating the United States and published in Chinese, content of which is herein incorporated by reference in its entirety.

### BACKGROUND

### 1. Technical Field

The present disclosure relates to the technical field of gimbal devices, and more specifically, to gimbals.

### 2. Background Information

Currently, portable photographing apparatuses such as mobile phones and digital cameras are increasingly popular with people. These photographing apparatuses may meet the requirements of users to photograph anytime and anywhere. However, to ensure photographing quality, a photographing apparatus is generally mounted on a gimbal, and the gimbal may keep the photographing apparatus mounted thereon stable to shoot clear pictures and videos during photographing. To enhance the portability of the gimbal, a foldable gimbal may be used. In the foldable gimbal, a wire harness needs to extend from a handle to a shaft arm of the gimbal. Therefore, the wire harness may have to pass through a folding and rotating part. In this way, the wire harness may move during the rotation of the folding and rotating part, thereby causing the wire harness to partially jam up, which may easily damage the wire harness and thus reduce the reliability of the gimbal.

### BRIEF SUMMARY

The present disclosure provides a gimbal.

Exemplary embodiments of the present disclosure provide a gimbal. The gimbal may include a first shaft assembly, a second shaft assembly, and a wire harness. The first shaft assembly may include a first shaft arm and a first motor, a first wiring space is formed in the first shaft arm, and a motor shaft of the first motor has a hollow structure. The second shaft assembly may include a second shaft arm and a second motor, the first shaft arm is rotatably connected to the second shaft arm, and a second wiring space is formed in the second shaft arm. The wire harness may pass through the motor shaft, the first wiring space, and the second wiring space in sequence, to electrically connect the first shaft assembly and the second shaft assembly, and the first shaft arm and the second shaft arm is rotatable relative to each other such that the gimbal is switchable between a folded state and a deployed state, and the first wiring space is configured so that when the gimbal switches between the folded state and the deployed state, a bending radius of a bending part of the wire harness accommodated in the first wiring space is no less than a minimum bending radius of the wire harness.

In the gimbal of the present disclosure, a wiring space for accommodating the wire harness is provided in the first shaft arm, and during state switching of the gimbal, a bending radius of a bending part of the wire harness accommodated in the wiring space is no less than the minimum bending radius of the wire harness. Therefore, the wire harness may be protected and prevented from being damaged by switching the state of the gimbal, and the reliability of the gimbal is improved.

The additional aspects and advantages of the embodiments of the present disclosure will be partly given in the following description, and part of them will become clear from the following description, or be understood through the practice of the embodiments of the present disclosure.

### BRIEF DESCRIPTION OF THE DRAWINGS

The foregoing and/or additional aspects and advantages of the present disclosure become more apparent and comprehensible in the descriptions of embodiments in combination with the accompanying drawings.

FIG. 1 is a schematic structural diagram of a gimbal in a deployed state according to exemplary embodiments of the present disclosure;

FIG. 2 is an enlarged schematic view of part II of the gimbal in FIG. 1;

FIG. 3 is another schematic structural diagram of a gimbal in a deployed state according to exemplary embodiments of the present disclosure;

FIG. 4 is a schematic plan view of a first wiring space according to exemplary embodiments of the present disclosure;

FIG. 5 is another schematic plan view of a first wiring space according to exemplary embodiments of the present disclosure;

FIG. 6 is still another schematic plan view of a first wiring space according to exemplary embodiments of the present disclosure;

FIG. 7 is a schematic structural diagram of a gimbal in a folded state according to exemplary embodiments of the present disclosure; and

FIG. 8 is still another schematic structural diagram of a gimbal in a deployed state according to exemplary embodiments of the present disclosure.

### DESCRIPTION OF MAIN COMPONENTS IN THE DRAWINGS

gimbal 100, first shaft assembly 10, first shaft arm 101, first motor 102, motor shaft 1021, first wiring space 103, circular wall 1031, opening 1032, guide member 1033, passage 1034, second shaft assembly 11, second shaft arm 111, second motor 112, second wiring space 113, first conduit 1131, third shaft assembly 12, third motor 121, third wiring space 122, third shaft arm 123, second conduit 1231, wire harness 13, handheld portion 14, cover 15, holder 16, mounting side 161, bearing portion 162, clamping arm 1621, and clamping opening 1622.

### DETAILED DESCRIPTION OF THE DRAWINGS

The following describes the embodiments of the present disclosure in detail. Examples of the embodiments are illustrated in the accompanying drawings, where identical or similar reference numerals always represent identical or similar components or components having identical or similar functions. The following embodiments described with reference to the accompanying drawings are exemplary and are used only to explain the present disclosure and should not be understood as limitations on the present disclosure.

In the descriptions of the present disclosure, it should be understood that directions or position relationships indicated by terms “center”, “longitudinal”, “lateral”, “length”, “width”, “thickness”, “up”, “down”, “front”, “rear”, “left”, “right”, “vertical”, “horizontal”, “top”, “bottom”, “internal”, “external”, “clockwise”, and “counterclockwise” are directions or position relationships based on the accompanying drawings, and are used only for conveniently describing the present disclosure and simplifying the descriptions, but do not indicate or imply that a corresponding apparatus or component must have a specific direction and must be constructed and operated in a specific direction, and therefore cannot be understood as limitations on the present disclosure. In addition, the terms “first” and “second” are intended only for description, and shall not be understood as an indication or implication of relative importance or an implicit indication of a quantity of indicated technical features. Therefore, a feature defined by “first” or “second” may explicitly or implicitly include one or more features. In the descriptions of the present disclosure, “plurality” means two or more unless otherwise defined.

In the descriptions of the present disclosure, it should be noted that unless otherwise specified and defined, terms “mounted”, “connected”, and “connection” should be understood in a broad sense. For example, the connection may be a fixed connection, or may be a detachable connection or an integrated connection. The connection may be a mechanical connection, or may be an electrical connection. The connection may be a direct connection, or may be an indirect connection through an intermediate medium, or may be an internal connection between two components or an interaction relationship between two components. A person of ordinary skill in the art may understand specific meanings of these terms in the present disclosure based on specific situations.

The following disclosure provides a plurality of different embodiments or examples for implementing different structures in the present disclosure. To simplify the disclosure of the present disclosure, the following describes components and arrangements in specific examples. Certainly, they are only examples and are not intended to limit the present disclosure. In addition, reference numerals and/or reference letters may be repeated in different examples in the present disclosure, and the repetition is for a purpose of simplification and clarity and does not indicate a relationship between various embodiments and/or arrangements discussed. In addition, the present disclosure provides examples of various specific processes and materials, but a person of ordinary skill in the art may be aware of application of other processes and/or use of other materials.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some exemplary embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some exemplary embodiments, the numerical parameters set forth in the written description and the appended claims are approximations, which may vary depending upon the desired properties sought to be obtained in a particular embodiment. In some exemplary embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the technical solution in this application in accordance with the embodiments of the present application. Therefore, the embodiments of the present application are not limited to those embodiments that have been precisely described in this disclosure.

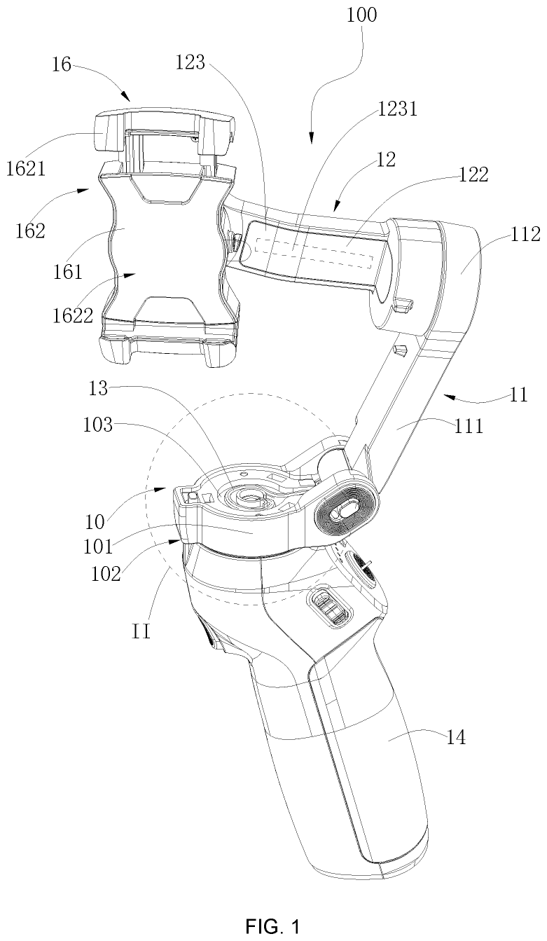

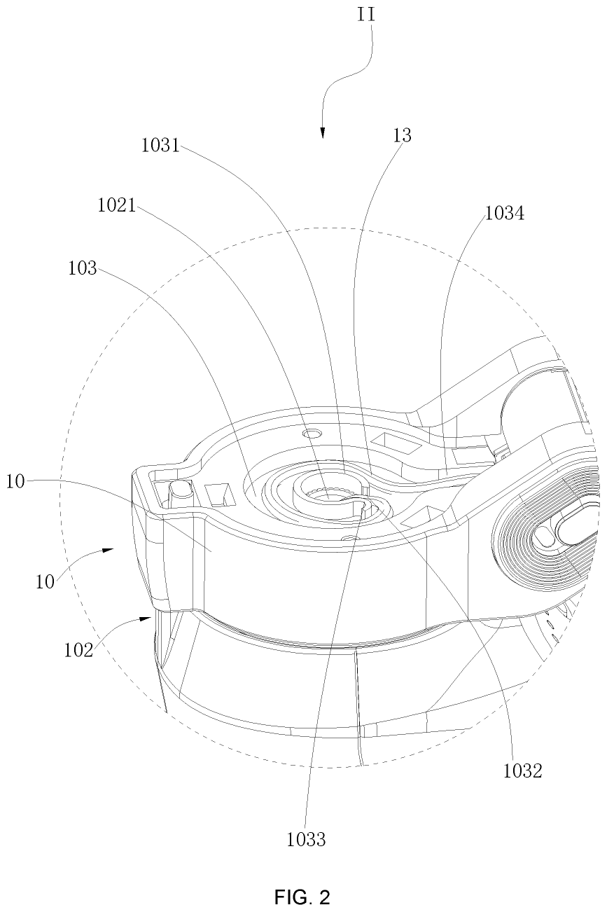

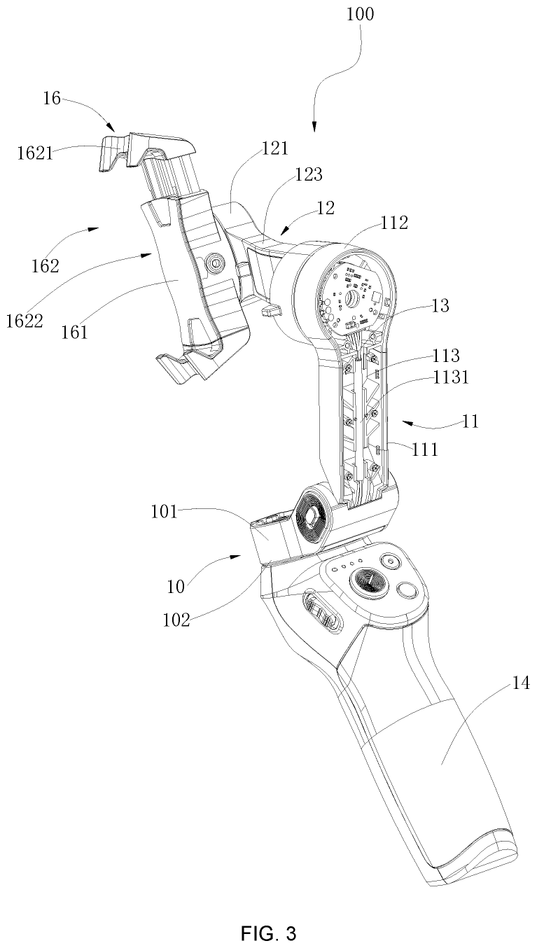

Referring to FIG. 1, FIG. 2, and FIG. 3, exemplary embodiments of the present disclosure may provide a gimbal 100. The gimbal 100 may be configured to carry a photographing apparatus such as a mobile phone, a tablet, a camera, and a camcorder to fix the photographing apparatus, implement a posture adjustment (for example, change a height, a tilt, and/or a direction of the photographing apparatus), and firmly keep the photographing apparatus in a determined posture.

In some exemplary embodiments, referring to FIG. 1 to FIG. 3, the gimbal 100 may include a first shaft assembly 10, a second shaft assembly 11, and a wire harness 13. The first shaft assembly 10 may include a first shaft arm 101 and a first motor 102. A first wiring space 103 may be formed in the first shaft arm 101. A motor shaft 1021 of the first motor 102 may have a hollow structure. The second shaft assembly 11 may include a second shaft arm 111 and a second motor 112. The first shaft arm 101 may be rotatably connected to the second shaft arm 111. A second wiring space 113 may be formed in the second shaft arm 111. The wire harness 13 may pass through the motor shaft 1021, the first wiring space 103, and the second wiring space 113 in sequence, so that the first shaft assembly 10 may be electrically connected to the second shaft assembly 11. When the first shaft arm 101 and the second shaft arm 111 rotate relative to each other, the gimbal 100 may switch between a folded state and a deployed state. The first wiring space 103 may be configured so that when the gimbal 100 switches between the folded state and the deployed state, a bending radius of a bending part of the wire harness 13 accommodated in the first wiring space 103 may be no less than a minimum bending radius of the wire harness 13.

In the gimbal 100 in the present disclosure, a wiring space for accommodating the wire harness 13 may be provided in the first shaft arm 101, and during state switching of the gimbal 100, a bending radius of a bending part of the wire harness 13 accommodated in the wiring space may be no less than the minimum bending radius of the wire harness 13. Therefore, the wire harness 13 may be protected and prevented from being damaged by switching the state of the gimbal 100, and the reliability of the gimbal 100 may be improved.

In some exemplary embodiments, the motor shaft 1021 may have a hollow structure, so that the wire harness 13 may pass through the motor shaft 1021 and that the wire harness 13 may enter the first wiring space 103.

Referring to FIG. 1 and FIG. 2, in some exemplary embodiments, the first wiring space 103 may be in an annular shape that surrounds the motor shaft 1021.

The first wiring space 103 may be in the annular shape, so that the wire harness 13 may extend around the motor shaft 1021 in the first wiring space 103 and that a part of the wire harness 13 in the first wiring space 103 may be also in the annular shape. Therefore, the wire harness 13 may be more orderly, and intertwining of the wire harness 13 may not occur.

Further referring to FIG. 1 and FIG. 2, in some exemplary embodiments, a circular wall 1031 may be disposed in the middle of the first wiring space 103, the motor shaft 1021 may be connected to the circular wall 1031, the circular wall 1031 may be provided with an opening 1032 connected to the first wiring space 103 and an inner space of the motor shaft 1021, and the wire harness 13 may pass through the opening 1032.

In some exemplary embodiments, the motor shaft 1021 may be located in the circular wall 1031, so that the motor shaft 1021 may be connected to the circular wall 1031 conveniently. Because the opening 1032 is connected to the first wiring space 103 and an interior of the motor shaft 1021, the wire harness 13 in the motor shaft 1021 may be guided into the first wiring space 103, and the wire harness 13 in the first wiring space 103 may extend around the circular wall 1031. Therefore, the location of the wire harness 13 may be limited by the circular wall 1031, and the intertwining of the wire harness 13 in the first wiring space 103 may be avoided.

Referring to FIG. 1 and FIG. 2, in some exemplary embodiments, a guide member 1033 for guiding the wire harness 13 into the first wiring space 103 may be disposed on a side of the opening 1032.

The guide member 1033 may guide the wire harness 13 into the first wiring space 103, to prevent the wire harness 13 from being damaged by its excessive bending. For example, when the guide member 1033 is not disposed at the opening 1032, the wire harness 13 may pass through the opening 1032 and may extend around the circular wall 1031. In this case, because the guide member 1033 is not disposed at the opening 1032, when the wire harness 13 is arranged to extend around the circular wall 1031, the wire harness 13 may bend around the circular wall 1031 at the opening 1032, and a bending angle of the wire harness 13 may be excessively large, which may cause damage to the wire harness 13. By providing the guide member 1033, excessive bending of the wire harness 13 may be avoided. Therefore, the wire harness 13 may be protected, and the reliability of the gimbal 100 may be improved.

In some exemplary embodiments, the guide member 1033 may be in an arc shape. The guide member 1033 may be arc-shaped. Therefore, when the wire harness 13 bends along the guide member 1033, excessive bending may not occur, and the guide member 1033 may not damage the wire harness 13. Furthermore, the service life of the wire harness 13 may be prolonged, the wire harness 13 may be prevented from being damaged by excessive bending, and the reliability of the gimbal 100 may be improved. It may be understood that the arc shape may be a circular arc shape, an arc shape conforming to other quadratic curves, or a combination of arc shapes conforming to a variety of different quadratic curves. The shape of the guide member 1033 may be set according to different situations. The specific shape of the guide member 1033 is not limited herein.

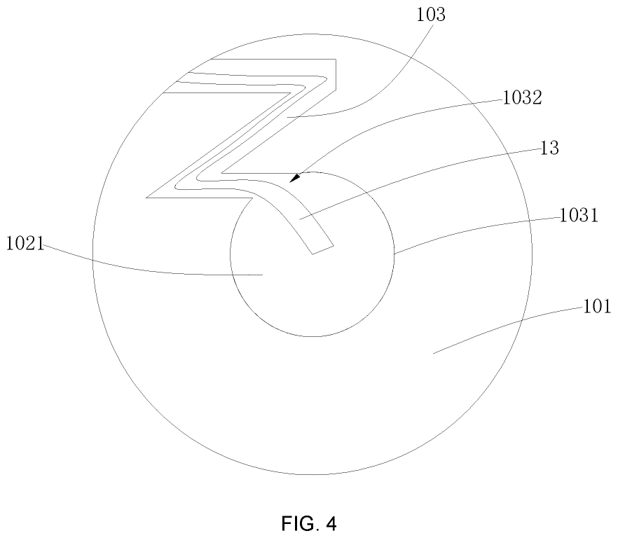

In some exemplary embodiments, referring to FIG. 4 to FIG. 6, the first wiring space 103 may be in a circuitous shape.

Because the first wiring space 103 is in the circuitous shape, space occupation of the first wiring space 103 may be reduced, and an interior of the first shaft arm 101 may provide more space for other structural components or electrical design.

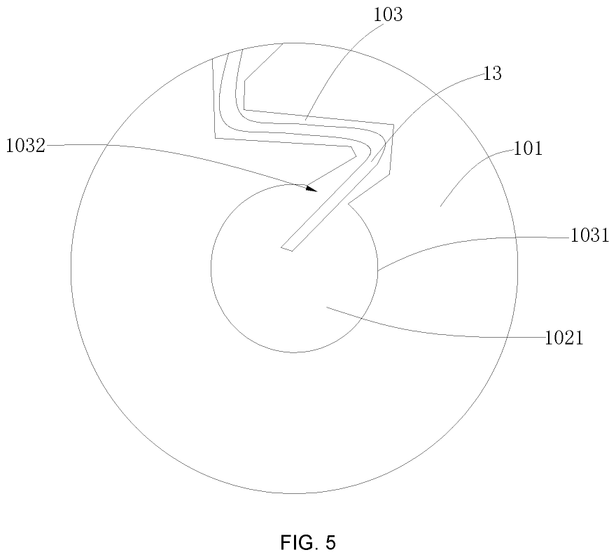

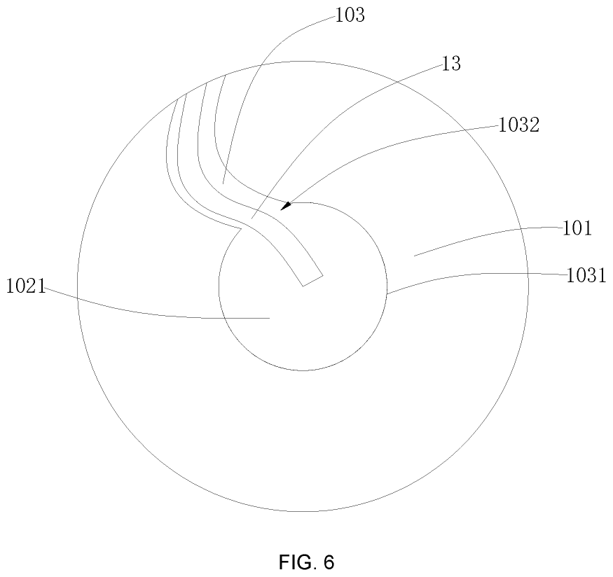

In some exemplary embodiments, the circuitous shape may include at least one of a Z shape, an S shape, and a C shape, or a combination thereof. In an example in FIG. 4, the circuitous shape may be the Z shape. In an example in FIG. 5, the circuitous shape may be the S shape. In an example in FIG. 6, the circuitous shape may be the C shape. It may be understood that the circuitous shape may not merely be the Z shape, the S shape, or the C shape. The specific circuitous shape may be set according to different situations. For example, in some exemplary embodiments, the circuitous shape may also be other shapes. The specific circuitous shape is not limited herein. In some exemplary embodiments, one or more turns of the circuitous shape may be processed to have an arc structure to protect the wire harness 13.

Referring to FIG. 1 and FIG. 2, in some exemplary embodiments, the first shaft arm 101 may be provided with a passage 1034 connected to the first wiring space 103 and the second wiring space 113, and the passage 1034 may extend from the first wiring space 103 to a rotatable connection part between the first shaft arm 101 and the second shaft arm 111.

By providing the passage 1034, it may be convenient for the wire harness 13 to enter the second shaft arm 111 from the first wiring space 103, and when the second shaft arm 111 rotates relative to the first shaft arm 101, the wire harness 13 may move along the passage 1034. Therefore, the wire harness 13 may conveniently move in the passage 1034 and may not move to areas other than the passage 1034. Therefore, the bending part of the wire harness 13 during state switching of the gimbal 100 may be reduced.

In some exemplary embodiments, the second wiring space 113 may extend along a length direction of the second shaft arm 111, an end of the second wiring space 113 may be connected to the passage 1034, and the wire harness 13 may enter the second wiring space 113 through the passage 1034.

The second wiring space 113 may extend along the length direction of the second shaft arm 111, so that the wire harness 13 may extend inside the second shaft arm 111 and that the required length of the wire harness 13 may be small. Therefore, the material of the wire harness 13 may be reduced, and costs are reduced. Because the passage 1034 is connected to the second wiring space 113, the wire harness 13 in the first wiring space 103 may enter the second wiring space 113 along the passage 1034. This may facilitate the arrangement of the wire harness in the first wiring space 103 and the second wiring space 113.

In some exemplary embodiments, a first conduit 1131 may be disposed in the second wiring space 113, and the wire harness 13 may pass through the first conduit 1131. Therefore, on one hand, the first conduit 1131 may protect the wire harness 13 and prevent the wire harness 13 from bending greatly during rotation of the gimbal 100. On the other hand, the first conduit 1131 may limit the moving range of the wire harness 13. In some exemplary embodiments, the wire harness 13 may usually include one or more wires. The wire harness 13 may include a plurality of wires. When the wire harness 13 is located in the second wiring space 113, the plurality of wires may be separated, and the operation of the gimbal 100 may be affected. By providing the first conduit 1131, the wire harness 13 may be located in the first conduit 1131, and the moving range of the wire harness 13 may be limited by the first conduit 1131. Such centralized management of the wire harness 13 may effectively resolve the problem that a single wire may be separated from the wire harness 13 and may prevent the wire harness 13 from being damaged by a structure inside the second shaft arm 111 when the wire harness 13 comes into contact with the structure inside the second shaft arm 111. Therefore, the service life of the wire harness 13 may be prolonged, and in some exemplary embodiments, the service life of the gimbal 100 may be prolonged.

In some exemplary embodiments, the first conduit 1131 may be made of plastic. The plastic may have strong plasticity and may be easy to obtain, which may be advantageous for manufacturing of the first conduit 1131 and may further be advantageous for mass production of the gimbal 100. It may be understood that the first conduit 1131 may not merely be made of plastic. The material of the first conduit 1131 may be selected according to different situations. For example, the first conduit 1131 may also be made of metal. The specific material of the first conduit 1131 is not limited herein.

In some exemplary embodiments, the first conduit 1131 may be a corrugated pipe. It may be understood that the first conduit 1131 may not merely be a straight pipe. The type of the first conduit 1131 may be set according to different situations. The specific type of the first conduit 1131 is not limited herein.

The first conduit 1131 may extend along the length direction of the second shaft arm 111.

Therefore, the wire harness 13 in the first conduit 1131 may extend along the length direction of the second shaft arm 111. This may be advantageous for connecting the wire harness 13 to the second motor 112. In addition, the fact that the first conduit 1131 extends along the length direction of the second shaft arm 111 may mean that the first conduit 1131 does not bend. This may reduce the material used for the first conduit 1131. Moreover, in this case, because the required length of the wire harness 13 is small, the material of the wire harness 13 may be reduced, and the costs are reduced.

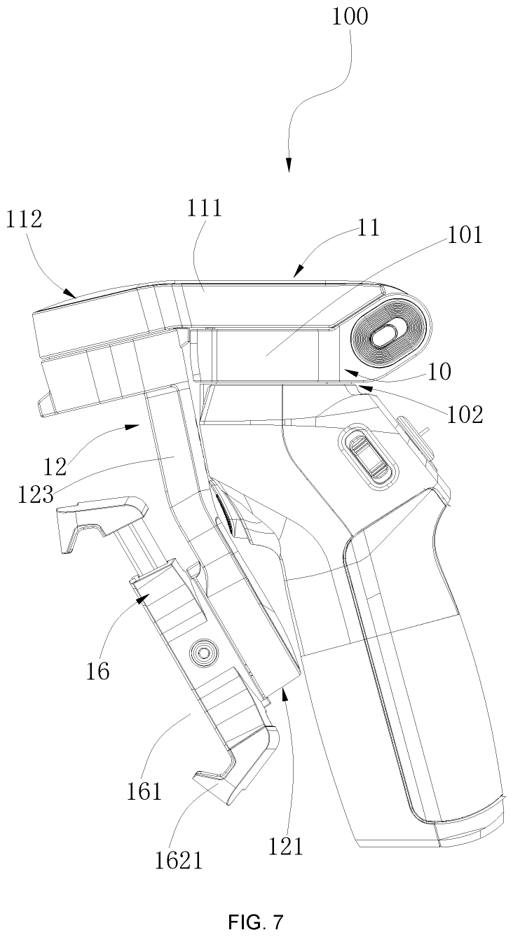

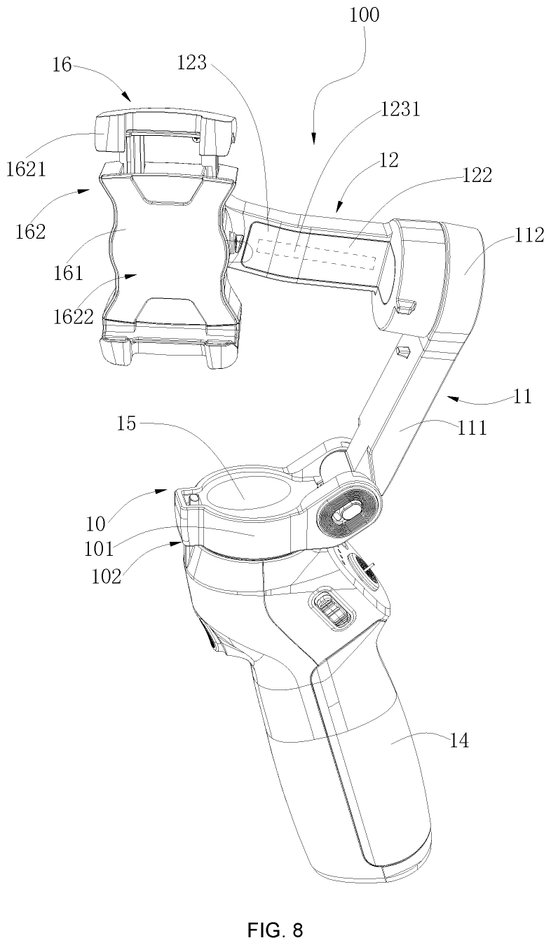

Referring to FIG. 3, FIG. 7, and FIG. 8, in some exemplary embodiments, the gimbal 100 may further include a third shaft assembly 12, the third shaft assembly 12 may include a third shaft arm 123 and a third motor 121, the third shaft arm 123 may rotate relative to the second shaft arm 111, a third wiring space 122 may be formed in the third shaft arm 123, and the wire harness 13 may pass through the motor shaft 1021, the first wiring space 103, the second wiring space 113, and the third wiring space 122 in sequence, so that the first shaft assembly 10, the second shaft assembly 11, and the third shaft assembly 12 may be electrically connected.

In this way, the third shaft assembly 12 may be configured to enable the photographing apparatus carried by the gimbal 100 to change to more postures (for example, change the height, tilt, and/or the direction of the photographing apparatus). Therefore, the user experience may be improved.

It may be understood that the gimbal 100 may not merely include the first shaft assembly 10, the second shaft assembly 11, and the third shaft assembly 12. In some exemplary embodiments, the gimbal 100 may further include a fourth shaft assembly, a fifth shaft assembly, and the like. A specific quantity of shaft assemblies of the gimbal 100 is not limited herein.

In some exemplary embodiments, a holder 16 may be also disposed on the third shaft assembly 12. One end of the third shaft arm 123 may be fixedly connected to the second motor 112, and the other end of the third shaft arm 123 may be fixedly connected to the third motor 121. The holder 16 may be fixedly connected to a rotor of the third motor 121.

Providing the holder 16 may help fix the photographing apparatus and prevent the photographing apparatus from loosening.

In some exemplary embodiments, the holder 16 may carry an imaging lens, and the imaging lens may be directly or indirectly fixedly connected to the rotor of the third motor 121. In some exemplary embodiments, the holder 16 may further include a bearing portion 162 configured to fix the photographing apparatus, where the photographing apparatus may be a camera, an intelligent terminal (such as a mobile phone or a tablet computer) having a photographing function, or another apparatus having a photographing function.

Referring to FIG. 1 and FIG. 8, in some exemplary embodiments, the third wiring space 122 may extend along a length direction of the third shaft arm 123.

Therefore, the wire harness 13 in a second conduit 1231 may extend along the length direction of the third shaft arm 123. This may be advantageous for connecting the wire harness 13 to the third motor 121.

In some exemplary embodiments, the second conduit 1231 may be disposed in the third wiring space 122, and the wire harness 13 may pass through the second conduit 1231.

Therefore, on one hand, the second conduit 1231 may protect the wire harness 13 and prevent the wire harness 13 from bending greatly during rotation of the gimbal 100. On the other hand, the second conduit 1231 may limit the moving range of the wire harness 13.

In some exemplary embodiments, the wire harness 13 may usually include one or more wires. The wire harness 13 may include a plurality of wires. When the wire harness 13 is located in the second wiring space 113, the plurality of wires may be separated, and the operation of the gimbal 100 may be affected. By providing the second conduit 1231, the wire harness 13 may be located in the second conduit 1231, and the moving range of the wire harness 13 may be limited by the second conduit 1231. Such centralized management of the wire harness 13 may effectively resolve a problem that a single wire may be separated from the wire harness 13, and may prevent the wire harness 13 from being damaged by a structure inside the third shaft arm 123 when the wire harness 13 comes into contact with the structure inside the third shaft arm 123. Therefore, the service life of the wire harness 13 may be prolonged, and in some exemplary embodiments, the service life of the gimbal 100 may be prolonged.

In some exemplary embodiments, the second conduit 1231 may be made of plastic. The plastic may have strong plasticity and may be easy to obtain, which may be advantageous for manufacturing of the second conduit 1231 and may further be advantageous for mass production of the gimbal 100. It may be understood that the second conduit 1231 may not merely be made of plastic. The material of the second conduit 1231 may be selected according to different situations. For example, the second conduit 1231 may also be made of iron. The specific material of the second conduit 1231 is not limited herein.

In some exemplary embodiments, the second conduit 1231 may be a corrugated pipe. It may be understood that the second conduit 1231 may not merely be a straight pipe. The type of the second conduit 1231 may be selected according to different situations. The specific type of the second conduit 1231 is not limited herein.

Referring to FIG. 3, FIG. 7, and FIG. 8, in some exemplary embodiments, the gimbal 100 may further include a handheld portion 14, the handheld portion 14 may be connected to the first shaft assembly 10, and the wire harness 13 may extend from the handheld portion 14 toward the motor shaft 1021, the first wiring space 103, the second wiring space 113, and the third wiring space 122, so that the handheld portion 14, the first shaft assembly 10, the second shaft assembly 11, and the third shaft assembly 12 may be electrically connected.

By providing the handheld portion 14, it may be convenient for a user to hold the gimbal 100 with a hand, so that the user uses the gimbal 100 conveniently.

In some exemplary embodiments, referring to FIG. 7, in an example shown in this figure, when the gimbal 100 switches to the folded state, the holder 16 may be located on one side of the third motor 121 away from a sidewall of the handheld portion 14.

Such configuration may facilitate the folding of the gimbal 100, so that the gimbal 100 may be easy to carry, which meets a requirement of a consumer for portability.

Still in some exemplary embodiments of the present disclosure, the holder 16 including the bearing portion 162 configured to fix the photographing apparatus may be used as an example for description. Referring to FIG. 1 and FIG. 3 to FIG. 8, the holder 16 may include a mounting side 161, and when the gimbal 100 is in the folded state, the mounting side 161 may face away from the handheld portion 14. In some exemplary embodiments, the photographing apparatus may be mounted on the mounting side 161. For example, when the photographing apparatus is a mobile phone, the mobile phone may be clamped or absorbed on the mounting side 161.

In this way, during the folding of the gimbal 100, because the mounting side 161 faces away from the handheld portion 14, there may be no need to remove the load clamped on the mounting side 161 before folding the gimbal 100. Therefore, when the gimbal 100 is deployed again, there may be no need to re-mount the load (for example, the photographing apparatus). In this way, the use of the gimbal 100 may be more convenient.

In addition, in some exemplary embodiments, a part of the holder 16 fitting onto the photographing apparatus (for example, a mobile phone) may be made of soft material with elasticity such as a silica gel or rubber to prevent the photographing apparatus from being scratched.

In the illustrated embodiments, the bearing portion 162 may be a clamping structure, and the clamping structure may be provided with a clamping opening 1622, so that photographing apparatuses of different sizes may be mounted on the holder 16. The clamping structure may include a clamping arm 1621 capable of adjusting the size of the clamping opening 1622.

When the gimbal 100 switches to the folded state, the clamping opening 1622 of the clamping structure may face away from the third motor 121. Providing the clamping opening 1622 of the clamping structure may ensure that when the gimbal 100 is stored, the photographing apparatus can face outside. For a user, this may facilitate the use of the photographing apparatus.

In some exemplary embodiments, for ease of holding, the handheld portion 14 may also be provided with a slip-proof portion to prevent the gimbal 100 from slipping off the user's hand. The slip-proof portion may be a frictional portion disposed on the handheld portion 14 or a recessed portion or a raised portion convenient for holding with fingers. It may be understood that the handheld portion 14 may be further provided with a protective apparatus such as a finger ring or a wristband that may sleeve over the user's finger or wrist, to further protect the gimbal 100 from slipping off the user's hand.

In addition, in some exemplary embodiments, to adjust a photographing angle of the photographing apparatus more accurately, a posture sensor may be disposed on the holder 16 to obtain posture information of the holder 16 and further obtain posture information of the load. The posture sensor may be communicatively connected to a controller to transmit the posture information of the photographing apparatus to the controller, and the controller may control the operation of the gimbal 100 based on the posture information of the photographing apparatus and a user instruction. The posture sensor may be a sensor capable of sensing the posture information of the photographing apparatus, such as a three-axis gyroscope, a three-axis accelerometer, and a three-axis electronic compass.

Referring to FIG. 8, in some exemplary embodiments, the gimbal 100 may further include a cover 15, and the cover 15 may be connected to the first shaft arm 101 and covers the first wiring space 103.

The cover 15 may be configured to cover the first wiring space 103. This may prevent vapor or dust in the air from entering the first wiring space 103, and damaging the wire harness 13 in the first wiring space 103, or damaging the first motor 102.

In some exemplary embodiments, the cover 15 may be made of plastic. Those skilled in the art would understand, the cover 15 may not merely be made of plastic. The specific material of the cover 15 may be selected according to different situations. For example, in some exemplary embodiments, the cover 15 may also be made of iron. The specific material of the cover 15 is not limited herein.

In some exemplary embodiments, the cover 15 may be detachably connected to the first shaft arm 101.

Such configuration may allow the cover 15 to be removed from the first shaft arm 101. Therefore, when the first motor 102 or the wire harness 13 in the first wiring space 103 malfunctions, the cover 15 may be removed, and the first motor 102 or the wire harness 13 in the first wiring space 103 may be repaired, maintained, or replaced to improve user experience.

The cover 15 may be connected to the first shaft arm 101 using a screw, an interference fit, a fastener, a threaded connection, bonding, or magnetic attraction. Therefore, the cover 15 may be detachably connected to the first shaft arm 101 conveniently. It may be understood that a specific connection mode between the cover 15 and the first shaft arm 101 may be selected based on an actual requirement. The specific connection mode between the cover 15 and the first shaft arm 101 is not limited herein.

In the descriptions of this specification, descriptions with reference to the terms “certain embodiments”, “one embodiment”, “some embodiments”, “exemplary embodiment”, “example”, “specific example”, “some examples”, and the like mean that specific features, structures, materials, or characteristics described with reference to the embodiment(s) or example(s) are included in at least one embodiment or example of the present disclosure. In this specification, exemplary descriptions of the foregoing terms may not refer to a same embodiment or a same example. In addition, the described specific features, structures, materials, or characteristics may be combined in one or more embodiments or examples in an appropriate manner.

Although the embodiments of the present disclosure have been illustrated and described above, it may be understood that the foregoing embodiments are exemplary and should not be understood as limitations on the present disclosure. A person of ordinary skill in the art may make changes, modifications, replacements, and variations to the foregoing embodiments without departing from the scope of the present disclosure.

What is claimed is:

1. A gimbal, comprising:
a first shaft assembly, including
a first shaft arm, having a first wiring space, and
a first motor, including a motor shaft having a hollow structure;
a second shaft assembly, including
a second shaft arm having a second wiring space, and
a second motor; and
a wire harness, passing through the motor shaft, the first wiring space, and the second wiring space in sequence, to electrically connect the first shaft assembly and the second shaft assembly,
wherein the first shaft arm is rotatably connected to the second shaft arm such that the gimbal is switchable between a folded state and a deployed state, and
the first wiring space is configured so that when the gimbal switches between the folded state and the deployed state, a bending radius of a bending part of the wire harness accommodated in the first wiring space is no less than a minimum bending radius of the wire harness.

2. The gimbal according to claim 1, wherein the first wiring space has an annular shape that surrounds the motor shaft.

3. The gimbal according to claim 1, further comprising a circular wall in a middle of the first wiring space to connect to the motor shaft, wherein
the circular wall includes an opening connected to the first wiring space and an inner space of the motor shaft, and
the wire harness passes through the opening.

4. The gimbal according to claim 3, further comprising a guide member on a side of the opening to guide the wire harness into the first wiring space.

5. The gimbal according to claim 4, wherein the guide member has an arc shape.

6. The gimbal according to claim 1, wherein the first wiring space has a circuitous shape.

7. The gimbal according to claim 6, wherein the circuitous shape includes at least one of a Z shape, an S shape, a C shape, or a combination thereof.

8. The gimbal according to claim 1, wherein
the first shaft arm includes a passage connected to the first wiring space and the second wiring space, and
the passage extends from the first wiring space to a rotatable connection part between the first shaft arm and the second shaft arm.

9. The gimbal according to claim 8, wherein
the second wiring space extends along a length direction of the second shaft arm,
an end of the second wiring space is connected to the passage, and
the wire harness enters the second wiring space through the passage.

10. The gimbal according to claim 1, wherein a first conduit is disposed in the second wiring space, and the wire harness passes through the first conduit.

11. The gimbal according to claim 10, wherein the first conduit extends along a length direction of the second shaft arm.

12. The gimbal according to claim 1, further comprising:
a third shaft assembly, including a third shaft arm and a third motor, wherein the third shaft arm is rotatable relative to the second shaft arm.

13. The gimbal according to claim 1, wherein
a third wiring space is formed in the third shaft arm, and
the wire harness passes through the motor shaft, the first wiring space, the second wiring space, and the third wiring space in sequence to electrically connect the first shaft assembly, the second shaft assembly, and the third shaft assembly.

14. The gimbal according to claim 13, wherein the third wiring space extends along a length direction of the third shaft arm.

15. The gimbal according to claim 13, wherein
a second conduit is disposed in the third wiring space, and
the wire harness passes through the second conduit.

16. The gimbal according to claim 13, further comprising:
a handheld portion, connected to the first shaft assembly, wherein the wire harness extends from the handheld portion toward the motor shaft.

17. The gimbal according to claim 16, wherein the wire harness passes through the first wiring space, the second wiring space, and the third wiring space to electrically connect the handheld portion, the first shaft assembly, the second shaft assembly, and the third shaft assembly.

18. The gimbal according to claim 1, further comprising:
a cover, connected to the first shaft arm and covering the first wiring space.

19. The gimbal according to claim 18, wherein the cover is detachably connected to the first shaft arm.

20. The gimbal according to claim 19, wherein the cover is connected to the first shaft arm by at least one of a screw, an interference fit, a fastener, a threaded connection, bonding, or magnetic attraction.
